(19) United States
(12) Patent Application Publication
(10) Pub. No.: US 2005/0092048 A1
(43) Pub. Date: May 5, 2005

(54) System for duplicating keys

(76) Inventor: Steven G. Mathena, Ft. Myers, FL (US)

Correspondence Address: Steven G. Mathena, 2524 Congress St. #4, Ft. Myers, FL, 33901, US

(21) Appl. No.: 10/699,026

(22) Filed: Nov. 3, 2003

(51) Int. Cl. E05B 19/20

(52) U.S. Cl. 70/394

(57) ABSTRACT

The invention is involved in a system for duplicating keys in vehicles having a cylindrical lock therein. The cylindrical lock has wafers therein. The wafers must be lined up in a certain position to make a shear line so that the key can operate the lock and turn it. The system involves a basic reading key that has a sliding reading bar in the same. When the sliding bar is forwarded all the way into the basic reading key, a reading of its position and depth can be taken and can be compared to a separate chart having indicia thereon pertaining to a particular make, model and year of a certain vehicle. This is accomplished by color coding the basic key reader and the chart to avoid any mistakes. Also, the basic key reader and the slide bar are color coded so, when separated from each, they can easily be reunited. Also, the basic key reader and the sliding bar reader have a way of locking into each other so that they cannot be easily separated from each other. Both of the basic reader key and the bar reader exhibit the same color so that they can always be matched relative to each other.

### BACKGROUND THE INVENTION

Most all automobile locks in these days contain 5 or more wafers or otherwise known as tumblers. These wafers are of different tolerances or dimensions depending on the depth of that cut. The dimensions are determined by inserting a reader bar into a passenger door lock all the way in until the bar stops which is the first wafer encountered. At that point a 5/16′ slot is cut at the tip of the key. When the reader bar is pulled back outward in the door lock, the wafer is forced into the slot due to spring tension behind the wafer. Once the wafer is trapped in the slot, the reader bar is slid outwardly. The reader bar has a 48 degree angle at the tip of the reader bar and once reinserted, the reader bar will touch the inside thickness of the wafer. Scribed indicators (or otherwise identified) on the reader bar will align with the proper align marks (5 or more). One of the depth of the five depths will line up. Thereafter, the reader bar is pushed inwardly and the angled tip of the reader bar will force the wafer out of its slot. The key is pulled slightly outwardly to thereby trap the next wafer and read that wafer and so on until all of the wafers have been read, Thereafter, the predetermined outs are performed on a code machine. The above operation are known as the prior art and the inventive concept will make an improvement over what has been shown above.

### DETAILED DESCRIPTION OF THE INVENTION

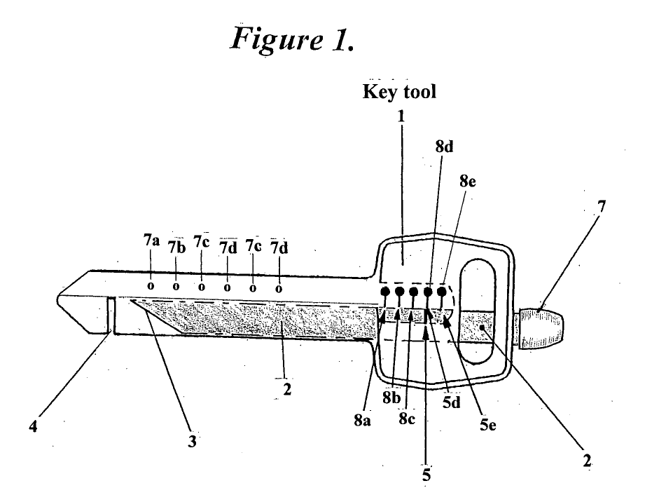

FIG. 1 illustrates the key reader or blank 1 that includes the reader bar 2 which is movable in and out of the basic key reader. The reader bar 2 has a forward end 3 which is slanted backward at a 48 degree angle. At the tip of the key reader there is a slot having a depth of 0.045″ and a width of 3/16′. The reader bar 2 has an alignment mark 5 for the purpose to be explained below. The key reader has spacing marks 7a-7d located along the forward end to indicate the spacing of the wafers located within the key reader 2. The reader bar has marks 8a-8e to indicate where a depth reading takes place. The knob 7 at the outer end of the reader bar 2 is color coded to coincide with color coding of the key reader. In this way, it can always be determined which reader 2 belongs to or is associated with which key reader, which has not been able to be done here to fore.

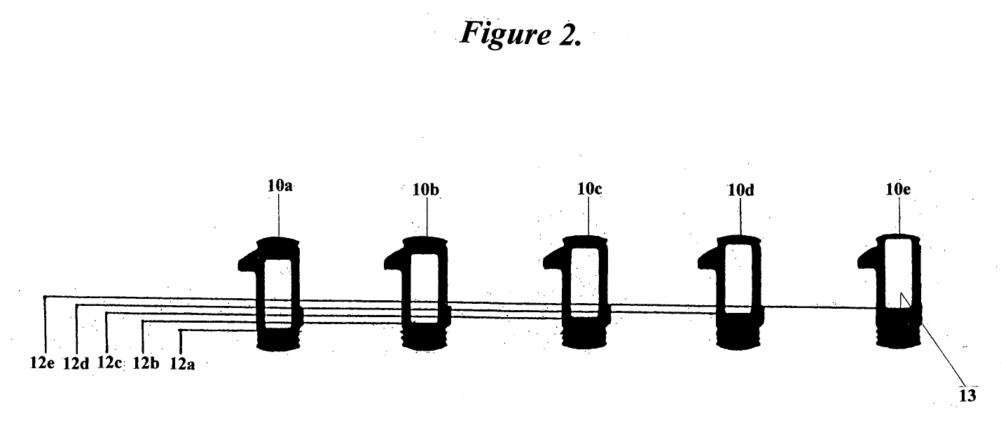

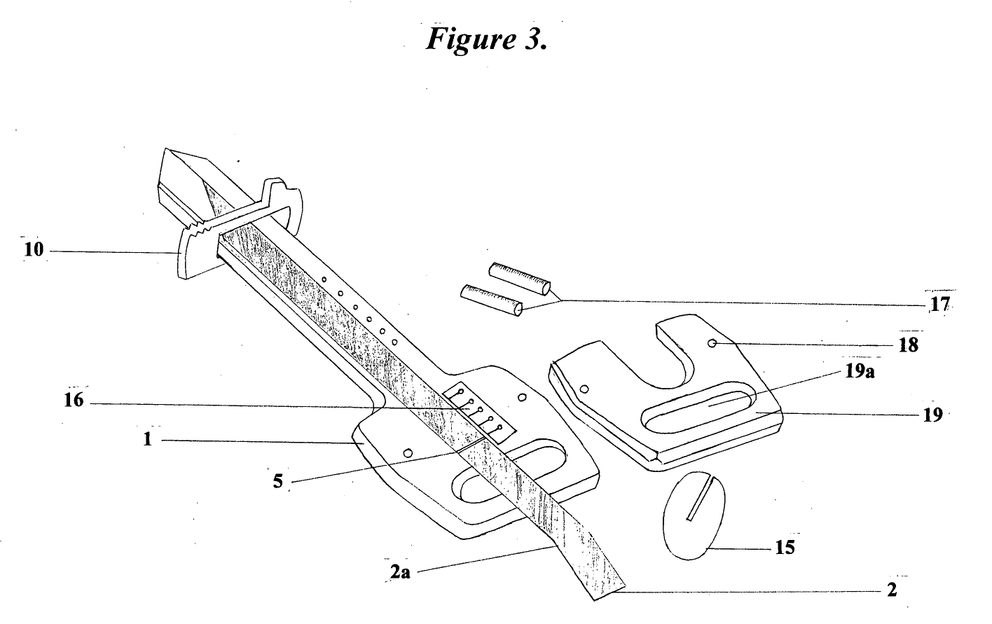

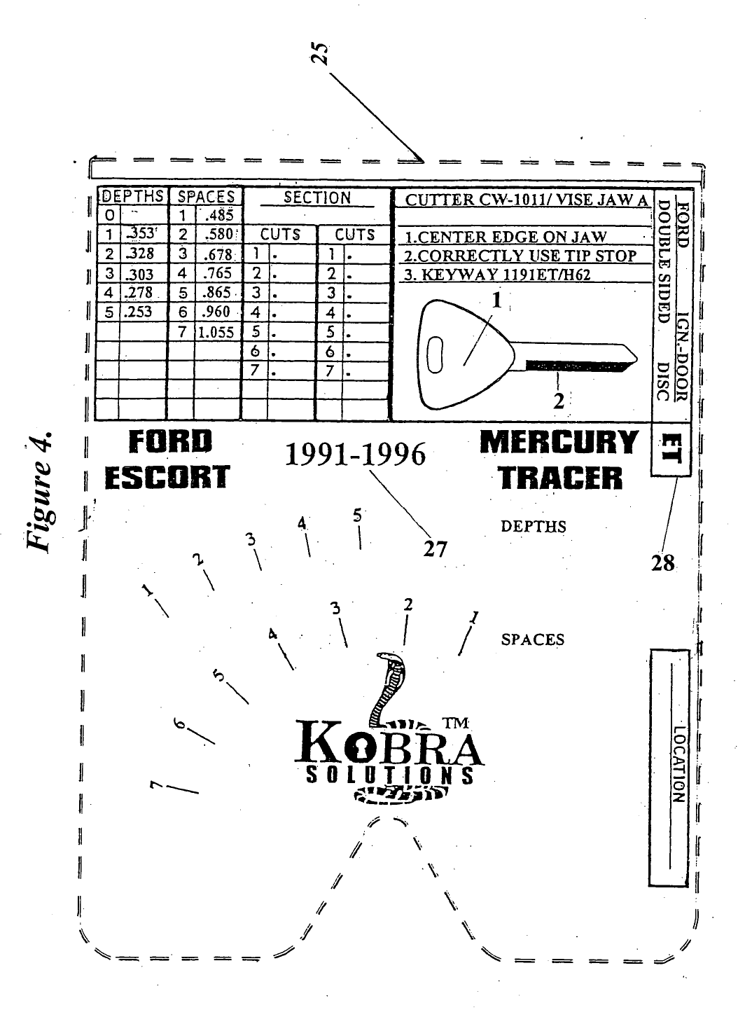

FIG. 3 is an exploded view of the key reader or the blank including the reader bar shown at 2 also as shown in FIGS. 1 and 2. Also shown is a water 10 in a position with the key just having passed through. The reader bar 2 may be passed or may slide through the key reader 1 until it touches the wafer 10 and then a reading may be taken at the point 5. At 16 there is shown a depth graph chart There Is a cover 19 that will cover the head of the key reader 1 but leave an opening 19a. The opening is important because the key reader 2a will visibly pass through the opening 19a. The reader bar has bend 2a induced therein. This bend, when pushed Into the opening 19 a will self-lock itself therein so that it cannot fall out of the opening. This feature represents a locking feature so that the reader bar 2 cannot accidentally get lost. It must be pulled out of the key reader by force. The reader key should be made out of tempered spring steel. FIG. 3 shows the knob 16 to be attached to the end of the reader bar 2. It helps to move the reader bar 2 within the key reader 1 but most importantly, the knob 15 is color coded to match the color coding on the key reader head 1. This way, if the bar reader 2 should be misplaced from the key reader, they can easily and visually be reunited with each other by way of the color. The cover 19 is fastened to the head of the key reader by way of rivets 17 passing through the holes 18 of the cover.

FIG. 2 illustrates the depths cut 12a-12e of the waters 10a-10e to be made depending on the readings of the reader bar. 13 indicates the reading at the tip of the reader bar 2 when it touches of the wafer. The reading will indicate the thickness or the depth that particular cut to be made.

1. A system for duplicating keys for cylindrical locks having wafers therein comprising a basic key reader to be inserted into a cylindrical lock, said basic key reader having a sliding bar reader therein, said sliding bar reader touching any of said wafers to determine a location, depths and spaces of said wafers, the obtained information can be read in an opening at the head of said key reader, said reader bar has a bend therein at its outer end to be locked in said opening of said basic key reader so that said reader bar cannot be lost accidentally.

2. A system for duplicating keys for cylindrical locks having wafers therein comprising a basic key reader to be inserted into a cylindrical lock, said basic key reader having a sliding bar reader therein, said sliding bar reader touching any of said wafers to determine a location, depths, and spaces of said wafers to obtain information can be read in an opening of the head of said key reader, said reader bar has a knob at an outer end thereof, said knob and said basic key reader have an identical color thereon.

3. A system for duplicating keys for cylindrical locks having wafers therein comprising a basic key reader to be inserted into said cylindrical lock, said basic key reader having a sliding bar reader therein, said sliding bar reader touching any of said wafers to determine a location, depths, and spaces of said wafers to obtain information, said information being recorded on a code card so as to the identify said information with vehicles having identical specification.
